(19) United States
(12) Patent Application Publication
(10) Pub. No.: US 2011/0294888 A1
(43) Pub. Date: Dec. 1, 2011

(54) Use of Salts of Sulfur-Containing Compounds for Controlling Parasites

(76) Inventors: Christoph Weckbecker, Grundau-Lieblos (DE); Kevin T. Riley, Flowery Branch, GA (US)

(21) Appl. No.: 12/979,508

(22) Filed: Dec. 28, 2010

(30) Foreign Application Priority Data
May 25, 2010 (DE) 102010029276.1

(51) Int. Cl. A01N 37/12; A01P 5/00

(52) U.S. Cl. 514/562

(57) ABSTRACT

The invention relates to a method of controlling nematodes with salts of sulphur-containing compounds.

The invention relates to a method of controlling nematodes using salts of sulphur-containing compounds.

The infestation of crop plants by nematodes causes enormous damage in agriculture. It is assumed that there are several thousand different nematode species which damage crop plants (SRI 2009). This gives rise to worldwide yield losses to the value of billions of Euros, especially in warm humid climates.

In the past, it was, therefore, preferably chemically-generated products which were used for controlling parasitic nematodes. The application of a majority of these substances has, over the years, been the subject of increasing bans, owing to their toxicity or their ozone-damaging effect. The economically most important product for this type of use is methyl bromide. This substance has been employed worldwide for the efficient and sustained control of parasitic nematodes. To improve the activity, the gas had been introduced into the soil and the treated surface has then been covered with films, which were only removed after several days or up to a few weeks in order to be able to continue to work the soil. This prolongs the contact time of methyl bromide or other gaseous nematicides with the parasites in the soil and therefore increases the efficiency of the application.

Despite these measures, however, it has not been possible to prevent the emission of large amounts of the active substance into the environment.

After these substances have been banned for application in agriculture, therefore, an extensive search for better active substances was started worldwide. In order to find biologically effective, economical alternatives to methyl bromide, the USDA has launched the “Methyl Bromide Alternatives National Program (308)” program. This was intended to support not only universities, but also industry, in finding more ecologically compatible and less costly follow-on products. Many products which are tested at a later point in time furthermore have the disadvantage that, being halogenated hydrocarbons, they can retain the abovementioned problems for humans and the environment which have already been mentioned above.

### PRIOR ART

US 2004/0228844 A1 discloses a method of controlling nematodes in which a mixture of methionine and a culture of Myrothecium verrucaria is employed. US 6,766,613 B2 describes a method of destroying nematodes using methionine. This is also found in US 2003/0140371 A1.

The fact that L-methionine and D,L-methionine can be employed efficiently against parasitic nematodes in turf and on golf courses (Crow, 2009) has been reiterated at the 48th “Annual Meeting of the Society of Nematologists” in Vermont.

### PROBLEM OF THE INVENTION

The problem posed to the skilled worker is to provide a composition for controlling nematodes, where this composition can be employed at a relatively high concentration in the form of a solution.

### Solution

It has been found that salts of methionine with alkali metal ions or alkaline-earth metal ions are suitable for use as nematicide in plant stands, in particular in stands of ornamentals. Methionine salts are commercially available in the form of existing commodities such as Liquimet or are obtained industrially during the production process when producing methionine (EP 0 959 068 B1, U.S. Pat. No. 6,126,972).

This means that no separate processing step for the preparation of basic methionine preparations is required. Rather, an inexpensive intermediate of the existing methionine synthesis may indeed be employed directly for this purpose. The solutions prepared by dissolving methionine in alkali metal/alkaline-earth metal solutions can likewise be employed. The advantage for the user is that it is not necessary to employ methionine itself in highly dilute form, due to its poor solubility, but that for example 5 to 75% strength solutions, in particular 10 to 50% strength solutions, are employed. If the user employs commercial methionine, he must, in order to avoid high dilution rates, apply suspensions which have the disadvantage that the solids sediment, making a uniform application of the substance difficult if not impossible.

Substances which are employed are, in particular, alkali metal methioninates or alkaline-earth metal methioninates, especially preferably sodium methioninate or potassium methioninate or mixtures of these. The pH of the solutions is generally >8, preferably 8 to 11.5.

According to the invention, it is, generally, crops of plants which are treated, especially crops of ornamentals.

The solutions are applied at from 5 to 50° C., in particular from 10 to 30° C.

By applying the methioninate solutions which comprise from 5 up to 75% by weight of methioninate, preferably from 10 to 50% by weight, especially preferably from 10 to 30% by weight, directly to the soil or to the plants, the use of methionine as nematicide is successfully simplified in a pronounced manner.

The application, of the methioninate solutions, according to the invention results in an improved activity as nematicide due to the improved soil penetration, which is the consequence of the higher solubility in water.

The methioninate employed in accordance with the invention as nematicide is used in the form of the soluble salts themselves or as mixtures of these with fertilizers and/or other pesticidal products such as herbicides, insecticides, fungicides, microbiocides or growth regulators.

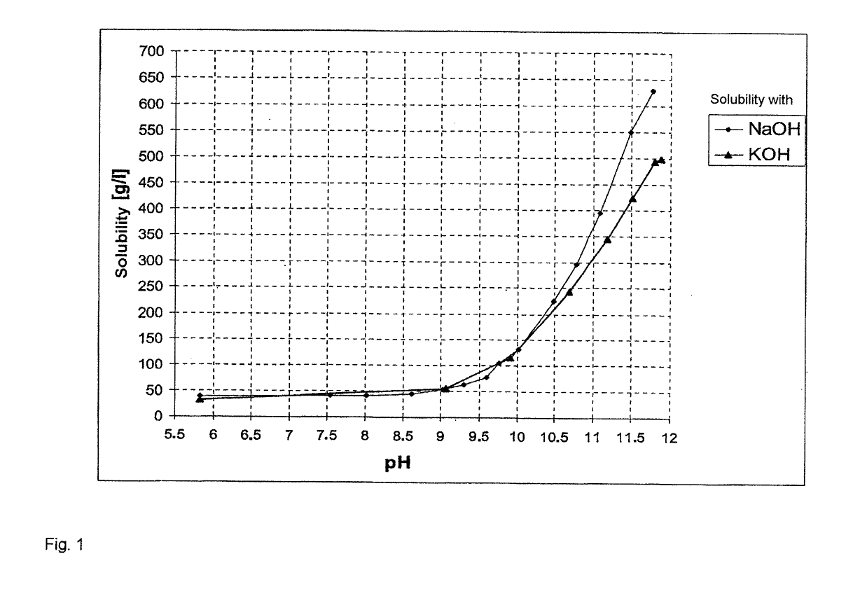

FIG. 1 shows the solubility of DL-methionine at 25° C. at different pH values and with different bases.

The measurement was carried out as follows: at 25° C., 200 g of DL-methionine were suspended in 200 ml of deionized water. After the mixture had been stirred for 30 min, a 1-ml sample was taken, filtered and diluted with deionized water by the factor 1000 with the aid of an Eppendorf pipette. This sample was analyzed by means of HPLC. Thereafter, the mixture was brought to the next pH using the aqueous base in question (50% strength), and stirring was continued for 30 min before a sample was taken. If appropriate, more solid methionine was added in order to obtain a supersaturated solution.

1. A method of controlling nematodes in crops of plants, in particular ornamentals, which comprises contacting the soil in which the plants grow and/or these plants with a solution of alkali metal salts or alkaline-earth metal salts of methionine.

2. The method according to claim 1, wherein the solution contains methioninate at a concentration of from 5 to 75% by weight, based on the total amount of the solution.

3. The method according to claim 1, wherein the solution contains methioninate at a concentration of from 10 to 50% by weight, based on the total amount of the solution.

4. The method according to claim 1, wherein the solution contains methioninate at a concentration of from 10 to 30% by weight, based on the total amount of the solution.

5. The method according to claim 1, wherein the pH of the solution is >8.

6. The method according to claim 1, wherein the solution comprises sodium methioninate.

7. The method according to claim 1, wherein the solution comprises potassium methioninate.

8. The method according to claim 1, wherein the alkali metal salts and the alkaline-earth metal salts of methionine are from a process for the preparation of methionine.

9. The method according to claim 1, wherein the solution further comprises fertilizers and/or herbicides, insecticides, fungicides, further herbicides, microbiocides, growth regulators, or mixtures thereof.
